(19) United States
(12) Patent Application Publication
(10) Pub. No.: US 2023/0107463 A1
(43) Pub. Date: Apr. 6, 2023

(54) METHOD AND SYSTEM FOR PROBABLY ROBUST CLASSIFICATION WITH MULTICLASS ENABLED DETECTION OF ADVERSARIAL EXAMPLES

(71) Applicant: Robert Bosch GmbH, Stuttgart (DE)

(72) Inventors: Sina BAHARLOUI, Los Angeles, CA (US); Fatemeh SHEIKHOLESLAMI, Pittsburgh, PA (US); Jeremy KOLTER, Pittsburgh, PA (US)

(21) Appl. No.: 17/487,497

(22) Filed: Sep. 28, 2021

(51) Int. Cl. G06N 3/08; G06N 3/04; G05B 13/02

(52) U.S. Cl. CPC G06N 3/08; G06N 3/04; G05B 13/027

(57) ABSTRACT

A method for training a machine-learning network includes receiving an input data from a sensor. The input data includes a perturbation. The method also includes obtaining a worst-case bound on a classification error and loss for perturbed versions of the input data. The method also includes training a classifier, where the classifier includes a plurality of classes, including a plurality of additional abstain classes. Each additional abstain class of the plurality of additional abstain classes is determined in response to at least bounding the input data. The method also includes outputting a classification in response to the input data indicating one of the plurality of classes and outputting a trained classifier in response to exceeding a convergence threshold. The trained classifier is configured to detect at least one additional abstain class of the plurality of additional abstain classes in response to obtaining the worst-case bound.

### TECHNICAL FIELD

The present disclosure relates to augmentation and image processing of an image utilizing machine learning.

### BACKGROUND

Machine learning networks may have adversarial training of neural networks for classification. The classifier performance may be robustified against such perturbations, but such systems may lack provable performance guarantees. Such networks have been increasingly shown to be lacking robustness.

### SUMMARY

An aspect of the disclosed embodiments includes a method for training a machine-learning network. The method includes receiving an input data from a sensor. The input data includes a perturbation and the input data is indicative of image, radar, sonar, or sound information. The method also includes obtaining a worst-case bound on a classification error and loss for perturbed versions of the input data, utilizing at least bounding of one or more hidden layer values. The method also includes training a classifier, where the classifier includes a plurality of classes, including a plurality of additional abstain classes. Each additional abstain class of the plurality of additional abstain classes is determined in response to at least bounding the input data. The method also includes outputting a classification in response to the input data indicating one of the plurality of classes and outputting a trained classifier in response to exceeding a convergence threshold. The trained classifier is configured to detect at least one additional abstain class of the plurality of additional abstain classes in response to obtaining the worst-case bound.

Another aspect of the disclosed embodiments includes a system, including a machine-learning network. The system also includes an input interface configured to receive input data from a sensor, wherein the sensor includes a video, radar, LiDAR, sound, sonar, ultrasonic, motion, or thermal imaging sensor. The system also includes a processor, in communication with the input interface, configured to: receive an input data from a sensor, the input data being indicative of image, radar, sonar, or sound information; train a classifier, the classifier including a plurality of classes, including a plurality of additional abstain classes, each additional abstain class of the plurality of additional abstain classes being determined in response to at least bounding input data including one or more perturbations; and output a trained classifier configured to detect at least one additional abstain class of the plurality of additional abstain classes in response in response to exceeding a convergence threshold.

Another aspect of the disclosed embodiments includes a system that includes a processor and a memory. The memory includes instructions that, when executed by the processor, cause the processor to: receive input data from a sensor, wherein the sensor includes a video, radar, LiDAR, sound, sonar, ultrasonic, motion, or thermal imaging sensor, wherein the input data is indicative of an image; obtain a worst case bound on a classification error and loss associated with perturbed versions of the input data, utilizing at least bounding of one or more hidden layer values; train a classifier of a machine-learning network, wherein the classifier includes a plurality of classes, including a plurality of additional abstain classes, wherein each additional abstain class of the plurality of additional abstain classes is determined in response to at least bounding input data including one or more perturbations; and output a trained classifier configured to detect at least one additional abstain class of the plurality of additional abstain classes in response to exceeding a convergence threshold.

### BRIEF DESCRIPTION OF THE DRAWINGS

FIG. 1 generally illustrates a system 100 for training a neural network according to the principles of the present disclosure.

FIG. 2 generally illustrates a computer-implemented method 200 for training a neural network according to the principles of the present disclosure.

FIG. 3 generally illustrates a data annotation system 300 to implement a system for annotating data according to the principles of the present disclosure.

FIG. 4 is an exemplary flow chart of a system training a neural network with robust classification of adversarial examples.

FIG. 5 generally illustrates a schematic diagram of an interaction between computer-controlled machine 10 and control system 12.

FIG. 6 generally illustrates a schematic diagram of the control system of FIG. 1 configured to control a vehicle, which may be a partially autonomous vehicle or a partially autonomous robot.

FIG. 7 generally illustrates a schematic diagram of the control system of FIG. 1 configured to control a manufacturing machine, such as a punch cutter, a cutter or a gun drill, of manufacturing system, such as part of a production line.

FIG. 8 generally illustrates a schematic diagram of the control system of FIG. 1 configured to control a power tool, such as a power drill or driver that has an at least partially autonomous mode.

FIG. 9 generally illustrates a schematic diagram of the control system of FIG. 1 configured to control an automated personal assistant.

FIG. 10 generally illustrates a schematic diagram of the control system of FIG. 1 configured to control a monitoring system, such as a control access system or a surveillance system.

FIG. 11 generally illustrates a schematic diagram of the control system of FIG. 1 configured to control an imaging system, for example an MRI apparatus, x-ray imaging apparatus or ultrasonic apparatus.

FIG. 12 is a flow diagram generally illustrating a classifier training method according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure concerns a method for training a neural network classification system with an abstain (rejection) option with provable robust (worst-case/adversarial) performance. The typical setup for an adversarial attack on a classifier, referred to herein as C, is as follows: given an input x with true label y that is correctly classified by C (meaning, C(x)=y), the attacker aims to find a small (ideally human-imperceptible) perturbation δ such that x+δ is incorrectly classified by C (that is, C(x+δ)≠y)). The proposed classifier has an additional class, called the abstain class (or the rejection/detection class), and the defense mechanism is designed such that it will either (1) classify adversarial perturbed inputs as the abstain/rejection/detection class, or (2) it will correctly classify it as the y class and thus prevents misclassification and fooling of the system.

There exists a large body of work in adversarial training of neural networks for classification (without rejection/abstain), where the classifier performance is robustified against such perturbations—these works lack provable performance guarantees.

A number of previous systems have proposed training procedures under which the resulting robustified classifier has provable performance, for example, an upper bound on the error rate (misclassification probability) for adversarial perturbed images subject to norm constraint on the perturbation.

In addition, in practice it is of interest to detect adversarially perturbed examples. However, all of the available detection methods in the literature lack provable performance, and have been shown to fail detection if the attacker devises carefully crafted “adaptive perturbations” to simultaneously evade detection and cause misclassification.

The raised challenge in proper testing of available detectors has made the need for detectors with provable performance imperative. Typical solutions include training a classifier with an extra class, for example, K+1 classes for a K-class classification task, where the extra class is referred to as the “abstain-class”. By classifying an image in this class, the classifier is in fact abstaining from declaring the input as any of the other K-classes, and thus can be thought of as abstaining (or detecting or rejecting) the adversarial input. However, such solutions have no provable performance guarantees.

Accordingly, systems and methods, such as those described herein, configured to augment the classification architecture and capabilities by using spurious abstain classes, denoted by M≥1 to increase the detection capability of the network. The systems and methods described herein may be configured to provide provable robustness guarantees obtained for multiclass-abstain network, yielding an increased provable performance guarantees.

In some embodiments, the systems and methods described herein may be configured to formulate a provable robust training procedure for neural networks for classification with a rejection class, in which models are trained to be provably robust to perturbations. To this end, the classifier is augmented with an extra class, resulting in a (K+M)-class classifier for a (K)-class classification task, and the adversarial perturbed inputs will be classified in extra (M) classes, referred to as abstain classes, a detection classes, or rejection-classes. Accordingly, the systems and methods described herein may be configured to mitigate, by detection of the adversarial inputs, deception of the network and misclassification.

In some embodiments, the systems and methods described herein may be configured to provide a training process for the classifier designed such that the classifier can provide guarantees on detection (abstaining) or correct-classification, thus together leading to failing of the attacker's objective, for a given input subject to a family of perturbations, such as norm constrained perturbations.

For training the aforementioned classifier, rather than minimizing the cross-entropy loss of the classifier, or optimally the robust cross entropy terms, the objective is first augmented with a term promoting classification of the adversarial inputs in the M detection (abstain) classes, where assignment to all such classes is considered valid and adaptively selected per input example for increased performance. The systems and methods described herein may be configured to minimize an upper bound of the worst-case loss of perturbed training samples (within a perturbation model) together with the traditional (robust) cross-entropy loss of the (clean) inputs. Thus, the increase in the cross-entropy of perturbed samples (attacks or not) is bounded, and the effect of the attack is mitigated.

In some embodiments, the systems and methods described herein may be configured to provide a robust certificate that provides a lower bound for classifier output on the correct as well as the abstain class for any perturbed sample within a given family of perturbations, providing guarantees of “detection or correct-classification”.

In some embodiments, the systems and methods described herein may be configured to enable detection of adversarial inputs by classifying them in the rejection classes. Additionally, or alternatively, the systems and methods described herein may be configured to provide provable guarantees on the performance of the classifier by giving a certificate that all possible perturbations within a family of perturbations will be either detected or the perturbed image will be correctly classified, thus guaranteeing unsuccessful attack by the adversary. The systems and methods described herein may be configured to provide a machine with increased capacity and an adaptive utilization of the enabled M-abstain classes, which may provide an additional boost in performance guarantee relative to guarantee achieved by other techniques without the detection capability.

In some embodiments, the systems and methods described herein may be configured to be used in detecting adversarial environments, and thus used for demanding manual control for safety-critical tasks by interpreting the detection of adversaries as unsafe/adversarial environment.

In some embodiments, the systems and methods described herein may be configured to abstain from classification, which may be interpreted as the classifier declaring lack of certainty in the outcome of the classification task, and thus can be used for declaring high uncertainty, where this performance is improved through utilization of M abstain classes (e.g., where M is greater than or equal to 1).

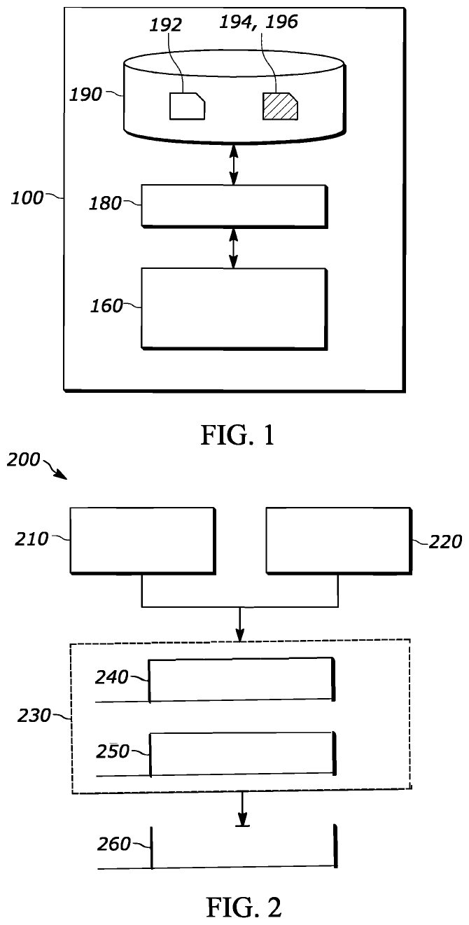

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180.

In some embodiments, the data representation 194 of the untrained neural network may be internally generated by the system 100 on the basis of design parameters for the neural network, and therefore may not explicitly be stored on the data storage 190. The system 100 may further comprise a processor subsystem 160 which may be configured to, during operation of the system 100, provide an iterative function as a substitute for a stack of layers of the neural network to be trained. In some embodiments, respective layers of the stack of layers being substituted may have mutually shared weights and may receive, as input, an output of a previous layer, or for a first layer of the stack of layers, an initial activation, and a part of the input of the stack of layers. The system 100 may also include multiple layers.

The processor subsystem 160 may be configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point. Determining the equilibrium point may include using a numerical root-finding algorithm to find a root solution for the iterative function minus its input, and by providing the equilibrium point as a substitute for an output of the stack of layers in the neural network.

The system 100 may include an output interface for outputting a data representation 196 of the trained neural network, this data may also be referred to as trained model data 196. For example, as is illustrated in FIG. 1, the output interface may be constituted by the data storage interface 180, with said interface being in these embodiments an input/output (“IO”) interface, via which the trained model data 196 may be stored in the data storage 190. For example, the data representation 194 defining the ‘untrained’ neural network may, during or after the training, be replaced, at least in part by the data representation 196 of the trained neural network, in that the parameters of the neural network, such as weights, hyperparameters and other types of parameters of neural networks, may be adapted to reflect the training on the training data 192. This is also illustrated in FIG. 1 by the reference numerals 194, 196 referring to the same data record on the data storage 190. In some embodiments, the data representation 196 may be stored separately from the data representation 194 defining the ‘untrained’ neural network. In some embodiments, the output interface may be separate from the data storage interface 180, but may in general be of a type as described above for the data storage interface 180.

FIG. 2 generally illustrates a computer-implemented method 200 for training a neural network. The method 200 may correspond to an operation of the system 100 of FIG. 1, or operation of any other suitable system, apparatus, or device or in that it may correspond to a computer program.

The method 200 is shown to comprise, in a step titled “PROVIDING DATA REPRESENTATION OF NEURAL NETWORK”, providing 210 a neural network, wherein the providing of the neural network comprises providing an iterative function as a substitute for a stack of layers of the neural network, wherein respective layers of the stack of layers being substituted have mutually shared weights and receive as input and output of a previous layer, or for a first layer of the stack of layers, an initial activation, and a part of the input of the stack of layers. The method 200 is further shown to comprise, in a step titled “ACCESSING TRAINING DATA”, accessing 220 training data for the neural network. The method 200 is further shown to comprise, in a step titled “ITERATIVELY TRAINING NEURAL NETWORK USING TRAINING DATA”, iteratively training 230 the neural network using the training data, which training 230 may comprise a forward propagation part and a backward propagation part. Performing the forward propagation part by the method 200 may comprise, in a step titled “DETERMINING EQUILIBRIUM POINT USING ROOT-FINDING ALGORITHM”, determining 240 an equilibrium point of the iterative function at which the iterative function converges to a fixed point, wherein determining the equilibrium point comprises using a numerical root-finding algorithm to find a root solution for the iterative function minus its input, and in a step titled “PROVIDING EQUILIBRIUM POINT AS SUBSTITUTE FOR OUTPUT OF STACK OF LAYERS”, providing 250 the equilibrium point as a substitute for an output of the stack of layers in the neural network. The method 200 may further comprise, after the training and in a step titled “OUTPUTTING TRAINED NEURAL NETWORK”, outputting 260 a trained neural network. The Deep Equilibrium (DEQ) neural network may be further described in the patent application titled “DEEP NEURAL NETWORK WITH EQUILIBRIUM SOLVER,” having application Ser. No. 16/985,852, filed Aug. 5, 2020, which is herein incorporated by reference in its entirety.

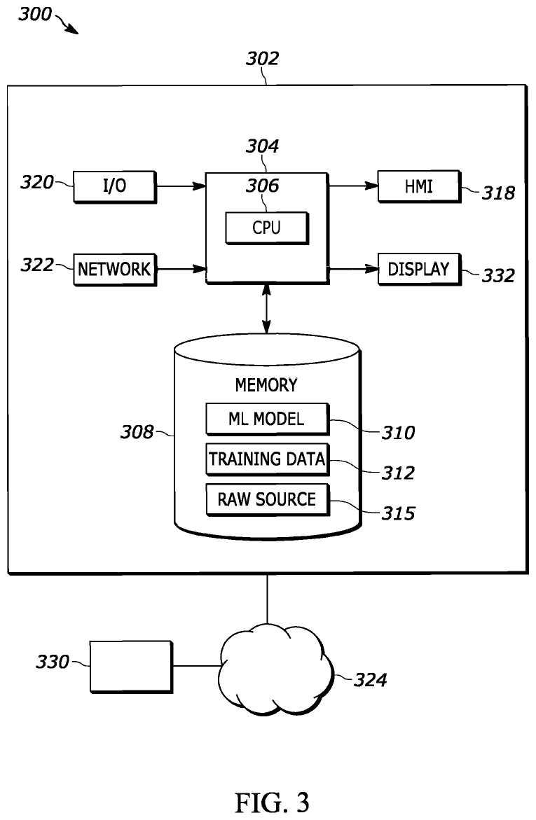

FIG. 3 generally illustrates a data annotation system 300 configured to annotate data. The data annotation system 300 may include at least one computing system 302. The computing system 302 may include at least one processor 304 that is operatively connected to a memory unit 308. The processor 304 may include one or more integrated circuits that implement the functionality of a central processing unit (CPU) 306. The CPU 306 may be a commercially available processing unit that implements an instruction stet such as one of the x86, ARM, Power, or MIPS instruction set families. During operation, the CPU 306 may execute stored program instructions that are retrieved from the memory unit 308. The stored program instructions may include software that controls operation of the CPU 306 to perform the operation described herein. In some embodiments the processor 304 may be a system on a chip (SoC) that integrates functionality of the CPU 306, the memory unit 308, a network interface, and input/output interfaces into a single integrated device. The computing system 302 may implement an operating system for managing various aspects of the operation.

The memory unit 308 may include volatile memory and non-volatile memory for storing instructions and data. The non-volatile memory may include solid-state memories, such as NAND flash memory, magnetic and optical storage media, or any other suitable data storage device that retains data when the computing system 302 is deactivated or loses electrical power. The volatile memory may include static and dynamic random-access memory (RAM) that stores program instructions and data. For example, the memory unit 308 may store a machine-learning model 310 or algorithm, a training dataset 312 for the machine-learning model 310, raw source dataset 315.

The computing system 302 may include a network interface device 322 that is configured to provide communication with external systems and devices. For example, the network interface device 322 may include a wired and/or wireless Ethernet interface as defined by Institute of Electrical and Electronics Engineers (IEEE) 802.11 family of standards. The network interface device 322 may include a cellular communication interface for communicating with a cellular network (e.g., 3G, 4G, 5G). The network interface device 322 may be further configured to provide a communication interface to an external network 324 or cloud.

The external network 324 may include the world-wide web or the Internet, or other suitable network. The external network 324 may establish a standard communication protocol between computing devices. The external network 324 may allow information and data to be easily exchanged between computing devices and networks. One or more servers 330 may be in communication with the external network 324.

The computing system 302 may include an input/output (I/O) interface 320 that may be configured to provide digital and/or analog inputs and outputs. The I/O interface 320 may include additional serial interfaces for communicating with external devices (e.g., Universal Serial Bus (USB) interface).

The computing system 302 may include a human-machine interface (HMI) device 318 that may include any device that enables the system 300 to receive control input. Examples of input devices may include human interface inputs such as keyboards, mice, touchscreens, voice input devices, and other similar devices. The computing system 302 may include a display device 332. The computing system 302 may include hardware and software for outputting graphics and text information to the display device 332. The display device 332 may include an electronic display screen, projector, printer or other suitable device for displaying information to a user or operator. The computing system 302 may be further configured to allow interaction with remote HMI and remote display devices via the network interface device 322.

The system 300 may be implemented using one or multiple computing systems. While the example depicts a single computing system 302 that implements all of the described features, it is intended that various features and functions may be separated and implemented by multiple computing units in communication with one another. The particular system architecture selected may depend on a variety of factors.

The system 300 may implement a machine-learning algorithm 310 that is configured to analyze the raw source dataset 315. The raw source dataset 315 may include raw or unprocessed sensor data that may be representative of an input dataset for a machine-learning system. The raw source dataset 315 may include video, video segments, images, text-based information, and raw or partially processed sensor data (e.g., radar map of objects). In some embodiments, the machine-learning algorithm 310 may be a neural network algorithm that is designed to perform a predetermined function. For example, the neural network algorithm may be configured in automotive applications to identify pedestrians in video images.

The computer system 300 may store a training dataset 312 for the machine-learning algorithm 310. The training dataset 312 may represent a set of previously constructed data for training the machine-learning algorithm 310. The training dataset 312 may be used by the machine-learning algorithm 310 to learn weighting factors associated with a neural network algorithm. The training dataset 312 may include a set of source data that has corresponding outcomes or results that the machine-learning algorithm 310 tries to duplicate via the learning process. In this example, the training dataset 312 may include source videos with and without pedestrians and corresponding presence and location information. The source videos may include various scenarios in which pedestrians are identified.

The machine-learning algorithm 310 may be operated in a learning mode using the training dataset 312 as input. The machine-learning algorithm 310 may be executed over a number of iterations using the data from the training dataset 312. With each iteration, the machine-learning algorithm 310 may update internal weighting factors based on the achieved results. For example, the machine-learning algorithm 310 can compare output results (e.g., annotations) with those included in the training dataset 312. Since the training dataset 312 includes the expected results, the machine-learning algorithm 310 can determine when performance is acceptable. After the machine-learning algorithm 310 achieves a predetermined performance level (e.g., 100% agreement with the outcomes associated with the training dataset 312), the machine-learning algorithm 310 may be executed using data that is not in the training dataset 312. The trained machine-learning algorithm 310 may be applied to new datasets to generate annotated data.

The machine-learning algorithm 310 may be configured to identify a particular feature in the raw source data 315. The raw source data 315 may include a plurality of instances or input dataset for which annotation results are desired. For example, the machine-learning algorithm 310 may be configured to identify the presence of a pedestrian in video images and annotate the occurrences. The machine-learning algorithm 310 may be programmed to process the raw source data 315 to identify the presence of the particular features. The machine-learning algorithm 310 may be configured to identify a feature in the raw source data 315 as a predetermined feature (e.g., pedestrian). The raw source data 315 may be derived from a variety of sources. For example, the raw source data 315 may be actual input data collected by a machine-learning system. The raw source data 315 may be machine generated for testing the system. For example, the raw source data 315 may include raw video images from a camera.

In some embodiments, the machine-learning algorithm 310 may process raw source data 315 and output an indication of a representation of an image. The output may also include augmented representation of the image. A machine-learning algorithm 310 may generate a confidence level or factor for each output generated. For example, a confidence value that exceeds a predetermined high-confidence threshold may indicate that the machine-learning algorithm 310 is confident that the identified feature corresponds to the particular feature. A confidence value that is less than a low-confidence threshold may indicate that the machine-learning algorithm 310 has some uncertainty that the particular feature is present.

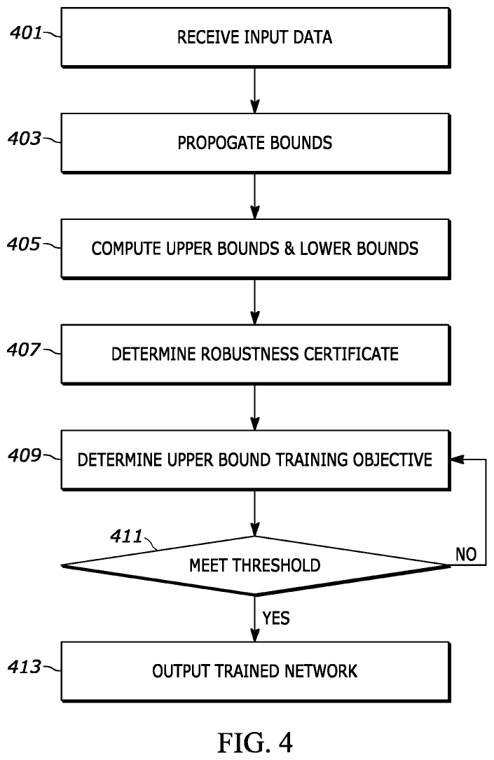

FIG. 4 generally illustrates a flow chart of a system training a neural network with robust classification of adversarial examples. In some embodiments, θ may denote the parameters of the classifier model, and (x,y)˜D the data used to train the model. Under traditional classifier objective, that is with no abstain class and no robustness guarantee, the model is trained by minimizing the cross-entropy objective

$${min}_{θ} {𝔼}_{( x , y ) \sim D} {ℓ}_{x e n t} ( {f}_{θ} ( x ) , y ) ≡ {min}_{θ} {\sum }_{( x , y ) \sim D} {ℓ}_{x e n t} ( {f}_{θ} ( x ) , y )$$

In order to provide guarantees on the robustness against a class of perturbations subject to a norm constrain, e.g., ∥δ∥ₚ≤ϵ for p=0, 1, 2, ∞, the common way in the literature is to solve the following certificate problem:

$${p}_{i}^{*} = {m}_{z ∈ \hat{{Z}_{L}}} {C}_{i}^{T} z ∀ i \neq y$$

where cᵢ=e_{y}−eᵢ for the eᵢ is the canonical vector of size K (equal to the total number of classes) with entry 1 at the i-th location and zero elsewhere, and similarly for e_{y} with y denoting the correct class. Furthermore, \hat{Z}={z_{L}|z_{L}<z̅_̅{̅L̅}̅<} denotes the feasible-set for the hidden layer values of the last layer of the neural networks. The upper and lower bounds of the feasible set is obtained by propagating the upper and lower bounds on the perturbed input bounded by the adversarial norm constraint ∥δ∥ₚ≤ϵ, done via various techniques, such as interval bound propagation (IBP) and CROWN.

If for a given test data(x,y), the aforementioned problem has the optimal solution pᵢ*≥0 for ∀i≠y, then it is guaranteed that no perturbation within the class of ∥δ∥ₚ≤ϵ can cause the input image (x+δ, y) to be misclassified.

To tighten the bound, for a network with L-Layers, the system may use the bounds on the layer (L−1) and use the explicit transformation of the last layer for mapping z_{L-1} into z_{L}, rendering the certification subproblem:

$${p}_{i}^{*} = {m}_{z ∈ \hat{{Z}_{L - 1}}} {C}_{i}^{T} {W}_{L} z ∀ i \neq y$$

with W_{L} denoting the affine transformation of the last layer of the neural network.

In order for the aforementioned problem to provide certification of robustness for a high number of input images, the training process is altered accordingly, such that the trained network is robust.

This can be accommodated by bounding the training objective (e.g., training objective function) by its worst-case upper bound via the interval bound propagation technique as

$${min}_{θ} {\sum }_{( x , y ) \sim D} {ℓ}_{x ent} ( {f}_{θ} ( x ) , y ) \leq {min}_{θ} {\sum }_{( x , y ) \sim D} {ℓ}_{xent} ( J ( x ) , y )$$

where 0≤α≤1 provides a convex combination of vectors m_{IBP} and m_{crown} as input to the cross-entropy loss, and the i-th entry of the vectors m_{IBP} and m_{crown} are given by pᵢ* for ∀i≠y for the certification subproblems given by bounds provided via IBP or CROWN methods, respectively.

In order to have more stable training, the system may use a combination of regular and robust loss functions for training, namely

$${min}_{θ} {\sum }_{( x , y ) \sim D} ( {κ}_{1} {ℓ}_{x e n t} ( J ( x ) , y ) + {κ}_{2} {ℓ}_{x e n t} ( {f}_{θ} ( x ) , y ) )$$

where, the coefficient 0≤κ≤1 may trade performance on clean images for robustness on adversarial perturbed images.

In some embodiments, the robust classifier may be augmented with multiple (denoted by M) abstain classes, detection classes, or rejection classes (which may be utilized to describe a special class individually, or all collectively). The examples classified in an of these classes will be interpreted as adversarial. Thus, the system may detect the adversarial images and the classifier may reject further assigning of these inputs into any of the regular classes.

The upper bounds and lower bounds may define a bounding box that may be utilized to predict an object location. Thus, an object detection system may draw a bounding box around each object of interest in an image or input data, and assign each bounding box a class label. Each perturbation of the image or input may be bounded (limited) to a certain distortion power. The system may model bounding each pixel in an input image to be changed by a maximum perturbation size.

At step 401, the system may receive an input data. The input data may be an image, sound, video, sonar/radar/Lidar data, etc. The input data may be retrieved from one or more sensors, such as a camera, microphone, Lidar sensor, radar sensor, sonar sensor, or any other input sensor. Certification in such a system may amount to guaranteeing that for a test data (x,y), all possible perturbations of input (x+δ,y) within the class of ∥δ∥ₚ≤ϵ will be either correctly classified or detected. Thus, if the solution to the following problem is positive, e.g., pᵢ*≥0 for ∀i≠y, where

$${p}_{i}^{*} = {min}_{z ∈ \hat{{Z}_{L}}} max \{ {C}_{y , i}^{T} z , {C}_{a \_ 1 , i}^{T} z , … , {C}_{a \_ M , i}^{T} z \} ∀ i \neq y$$

where c_{y,i}=e_{y}−eᵢ for the et is the canonical vector of size K+M (equal to the total number of classes (K) plus the abstain/detection classes (M)) with entry 1 at the i-th location and zero elsewhere, and similarly

$${C}_{{a}_{m} i} = {e}_{{a}_{m}} - {e}_{i}$$

with aₘ indexing the m-th abstain class for m=1, 2, . . . , M.

This optimization can be lower-bounded via the corresponding dual optimization as

$${p}_{i}^{*} \geq \hat{{p}_{l}^{*}} := {max}_{0 \leq η j , i \leq 1} {min}_{z ∈ \hat{{Z}_{L}}} {η}_{0 , i} {C}_{y , i}^{T} z + {η}_{1 , i} {C}_{{a}_{1}}^{T} z + … + {η}_{M , i} {C}_{{a}_{M} , i}^{T} z ∀ i \neq y \\ s . t . {η}_{0 , i} + {η}_{1 , i} + … + {η}_{M , i} = 1 \qquad ( P1 )$$

Upper and lower bounds of the feasible set [symbol] in the optimization can be provided by IBP or CROWN or any other similar techniques.

Consequently, the training process is changed such that it accommodates the certification optimization objective, rendering the training as minimization of the loss function

$${min}_{θ} L = {min}_{θ} \frac{1}{n} {\sum }_{\{ {x}_{i} , {y}_{i} \} \sim D , i = 1}^{n} {L}_{\{ R o bust \} ( {x}_{i} , {y}_{i} , θ )} + {λ}_{1} {L}_{\{ R o bust \} ( {x}_{i} , {y}_{i} , θ )}^{\{ abstain \}} + {λ}_{2} {L}_{\{ Natural \} ( {x}_{i} , {y}_{i} , θ )}$$

$${L}_{Natural \} ( {x}_{i} , {y}_{i} , θ )} = {ℓ}_{\{ xent \} σ ( {x}_{i} ) , {y}_{i} )}$$

$$and$$

$${ℒ}_{robust} ( {x}_{i} , θ ) := {max}_{\{ {δ}_{1} , … , {δ}_{n} \} :} {ℓ}_{\{ x e n t \} ( f ( ∖ b {x}_{i} + {δ}_{i} ) , {y}_{i} )} subject to : {‖ {δ}_{i} ‖}_{∞} \leq ϵ$$

$$and$$

$${L}_{\{ R o bust \} ( {x}_{i} , {y}_{i} , θ )}^{\{ abstain \}} = {max}_{\{ δ \}} min ( {l}_{\{ xent \} ( f ( x , θ ) , y )} , {l}_{\{ xent \backslash a \_ 1 \} ( f ( x , θ ) , {a}_{1} )} , … , {l}_{\{ xent \} ( f ( x , θ ) , {a}_{M} )} )$$

Where defined is

$${ℓ}_{\{ xent ∖ {a}_{j} \} ( x , θ , y )} = - log \frac{exp ( {z}_{y} )}{{\sum }_{\{ i ∈ I ∖ {a}_{j} \}} exp ( {z}_{i} )}$$

The robust terms can be upprbounded by utilizing duality theory in optimization as well as bound propagation technique such as IBP leading to:

$${L}_{\{ R o bust \} ( x , y , θ )}^{\{ abstain \}} \leq \overline{{\{ L \}}_{\{ R o bust \}}^{\{ abstain \} ( ∖ b x , θ , y )}} = {ℓ}_{\{ xent ∖ {A}_{0} \} ( J ( x , {η}_{i} ) , θ , {y}_{i} )}$$

$${A}_{0} = \{ {a}_{1} , … , {a}_{M} \}$$

In some embodiments, the system described in the disclosure trains the classifier and provides certification, as explained below. The system may receive an input data that is utilized for training. The system may train the classifier upon exceeding a convergence threshold.

Thus, the input may include: training data X={(x₁,y₁), . . . , (xₙ,yₙ)}, xᵢ ∈ [symbol] ^{M} and yᵢ∈{1, 2, . . . , K}, training robustness value ϵₜᵣₐᵢₙ FOR x∈X

At step 403, the system may propagate bounds to compute a robustness certificate. The system may consider a classifier parameterized with network parameters θ and (K+M) outputs where K of them correspond to the original classes in the data, and extra M classes correspond to the abstain/rejection/detection classes.

The system may compute upper x̅ and lower x bounds on input x

x̅=(x+ϵₜᵣₐᵢₙ1); x=(x−ϵₜᵣₐᵢₙ1)

At step 405, the system may computer upper and lower bound of the hidden values of the network. The system may compute upper and lower bound of the hidden values of the network at layer L−1, as shown in the formula below:

z_{L-1}=min{z_{L-1}(x)},z_{L-1}(x̅), z̅_̅{̅L̅-̅1̅}̅=max{z̅_̅{̅L̅-̅1̅}̅(x), z̅_̅{̅L̅-̅1̅}̅(x)}

At step 407, the system may determine or operate a robustness certificate. The system may calculate various parameters to ensure robustness. The system may compute ηᵢ=[η_{0,i}, η_{1,i}, . . . , η_{M,i}] for ∀i=1, 2, . . . , K, i≠y

$${p}_{i}^{*} \geq := {max}_{0 \leq η j , i \leq 1} {min}_{z ∈ \hat{{Z}_{L}}} {η}_{0 , i} {C}_{y , i}^{T} z + {η}_{1 , i} {C}_{{a}_{1}}^{T} z + … + {η}_{M , i} {C}_{{a}_{M} , i}^{T} z ∀ i \neq y \\ s . t . {η}_{0 , i} + {η}_{1 , i} + … + {η}_{M , i} = 1 \qquad ( P1 )$$

If [symbol] ≥0 for all ∀i=1, 2, . . . , K, i≠y, then robustness of the classifier for sample (x,y) is guaranteed.

The system may solve by maximizing J(η) defined as:

$$J ( η ) = {min}_{z ∈ \hat{{Z}_{L}}} {η}_{0 , i} {C}_{y , i}^{T} z + {η}_{1 , i} {C}_{{a}_{1} , i}^{T} z + … + {η}_{M , i} {C}_{{a}_{M} , i}^{T} z$$

constrained to the simplex feasible set η_{0,i}+η_{1,i}+ . . . +η_{M,i}=1 using an Augmented Lagrangian or a Bergman Divergence algorithm as outlined in Algorithm 1 or 2, as described herein.

At step 409, the system may compute an upper bound of a training objective. The system may compute the upper bound of training objective utilizing the following:

[symbol]

_{regular}(xᵢ,θ)= [symbol] ₓₑₙₜ(x,y)

[symbol]

_{robust}(xᵢ,θ)≤ [symbol] _̅{̅r̅o̅b̅u̅s̅t̅}̅(̅x̅ᵢ̅,̅θ̅)̅= [symbol] ₓₑₙₜ(J(e_{y}),y)

[symbol]

_{robust}^{abstain}(xᵢ,θ)≤ [symbol] _̅{̅r̅o̅b̅u̅s̅t̅}̅^̅{̅a̅b̅s̅t̅a̅i̅n̅}̅(̅x̅ᵢ̅,̅θ̅)̅= [symbol] ₓₑₙₜ(J(e_{y}),y)

where η are obtained by solving the optimization in (P1) and e_{y} is the canonical vector which is 1 at the position of the correct label y.

Finally obtain upper bound on

[symbol]

(̅x̅ᵢ̅,̅θ̅)̅=κ₁ [symbol] _{regular}(xᵢ,θ)+κ₂ [symbol] _{robust}(xᵢ,θ)+κ₃ [symbol] _{robust}^{abstain}(xᵢ,θ)

The system may also optimize the robustness certificate and classifier. For example, the update network parameters to improve robustness and its certificate:

$$θ ← θ - \frac{1}{n} {\sum }_{i = 1 , … , n} ∇ \overline{ℒ ( {x}_{i} , θ )}$$

Algorithm 3, as described herein, outlines the steps of the classification training.

The system may then output such information. The system may receive an input data that is utilized for training. The system may train the classifier upon exceeding a convergence threshold. At decision 411, the system may determine if the network as met a convergence threshold. If the system has not met the convergence threshold, it will continue to train the network. However, if convergence is met, the system will output the trained network. At step 413, the output may be a trained network. Thus, the robustly trained (K+M)-class classifier may be configured to enable a detection/rejection/abstain class with parameters θ.

The system may also work on a robustness certificate. During a test phase, for test pair (x,y) problem (P1) is solved and if [symbol] ≥0, then robustness is guaranteed in terms of guaranteeing that misclassification will not occur as either correct classification or successful detection is guaranteed for all perturbations (x+δ) within the class of ∥δ∥ₚ≤ϵ.

Algorithm 1
Applying Method of Multipliers to Function J

| | |
|---|---|
| 1: | Input: step-size α, number of iterations R, augmented Lagrangian |
| | parameter ρ. |
| 2: | for t = 0, 1, . . . , R do |
| 3: | ${η}_{i} ← {[ {η}_{i} + α ( \frac{\partial J}{\partial {η}_{i}} - {λ}_{t} - ρ ( {\sum }_{i = 0}^{i = M} {η}_{i} - 1 ) ) ]}_{+} ∀ i = 0 , . . . , M .$ |
| 4: | ${λ}_{t + 1} ← {λ}_{t} + ρ ( {\sum }_{i = 0}^{i = M} {η}_{i} - 1 )$ |
| 5: | end for |

Algorithm 2
Applying Bergman Divergence Method on J

| | |
|---|---|
| 1: | Input: Bergman divergence coefficient α, number of iterations R. |
| 2: | for t = 0, 1, . . . , R do |
| 3: | ${η}_{i}^{t + 1} = \frac{{η}_{i}^{t} exp ( - 2 α \frac{\partial J}{\partial \text{?}} )}{{\sum }_{j = 0}^{M} {η}_{j}^{t} exp ( - 2 α \frac{\partial J}{\partial \text{?}} )}$ |
| 4: | end for |

$\text{?} \text{indicates text missing or illegible when filed}$

Algorithm 3 Train a robust neural network on a training data

| | |
|---|---|
| 1: | Input: Batches of data [symbol] ₜ , . . . , [symbol] _{N}. |
| 2: | for t = 1, . . . , N do |
| 3: | Compute J(x) ∀ x ∈ [symbol] ₜ using Algorithm 2. |
| 4: | Compute \ddot{L}_{Robust}^{abstain} ( [symbol] ₜ, θ, y) = Σ_{x∈} [symbol] t [symbol] (J(x), θ, y). |
| 5: | Compute L_{Robust}( [symbol] ₜ, y, θ) and L_{Natural}( [symbol] ₜ, y, θ). |
| 6: | L = L_{Robust}( [symbol] ₜ, y, θ) + λ₁L_{Robust}^{abstain}( [symbol] ₜ, y, θ) + λ₂L_{Natural}( [symbol] ₜ, y, θ) |
| 7: | Apply one step of stochastic gradient descent (batch version) to L. |
| 8: | end for |

In some embodiments, the system may utilize interval bound propagation (IBP) to compute the output bounds, and can be using any methods, such as CROWN or any other IBP methods (e.g., Tensor Flow) and CROWN.

Parameters [η₁, . . . , η_{K}] (e.g., where each ηᵢ is an (M+1)-dimensional vector) can be obtained by solving the certificate subproblem for each of these techniques separately, CROWN bounds may be better approximated during the initial steps of the training phase, and IBP bounds are tighter bounds in later stages of the training. However, the system may determine that generally all choices of bound propagation methods are valid

The certification can be similarly obtained by extending Beta-CROWN] through introduction of the parameters [η₁, . . . , η_{K}] and further tightening the provable certifications of Beta-CROWN through the corresponding dual optimization similar to IBP and Beta-CROWN.

All choices of 0≤η_{j,i}≤1 may be valid. Utilizing η_{0,i}=1 reduces the certification process to the case where there is no abstain/detect/reject capability for the classifier, (e.g., previous works of IBP and CROWN). Utilization of η_{0,i}=0 is a more stringent choice for a classifier with rejection and can be applied to reduce complexity of solving the (P1) opt per samples. On the positive side it reduces complexity. Optimal value of η_{j,i} for the certificate subproblem is solved during the test phase for a tighter/better certificate.

For better generalization, the system may restrain the feasible set of 0≤η_{j,i}≤1 to 0<η≤η_{j,i}≤η̅<1 during the training process.

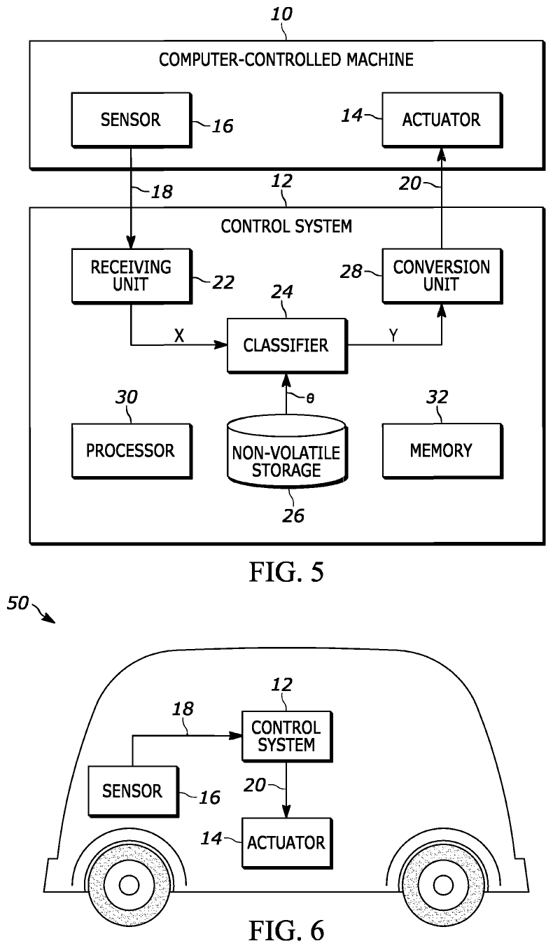

FIG. 5 depicts a schematic diagram of an interaction between computer-controlled machine 10 and control system 12. The computer-controlled machine 10 may include a neural network as described in FIGS. 1-4. The computer-controlled machine 10 includes actuator 14 and sensor 16. Actuator 14 may include one or more actuators and sensor 16 may include one or more sensors. Sensor 16 is configured to sense a condition of computer-controlled machine 10. Sensor 16 may be configured to encode the sensed condition into sensor signals 18 and to transmit sensor signals 18 to control system 12. Non-limiting examples of sensor 16 include video, radar, LiDAR, ultrasonic and motion sensors. In some embodiments, sensor 16 is an optical sensor configured to sense optical images of an environment proximate to computer-controlled machine 10.

Control system 12 is configured to receive sensor signals 18 from computer-controlled machine 10. As set forth below, control system 12 may be further configured to compute actuator control commands 20 depending on the sensor signals and to transmit actuator control commands 20 to actuator 14 of computer-controlled machine 10.

As shown in FIG. 5, control system 12 includes receiving unit 22. Receiving unit 22 may be configured to receive sensor signals 18 from sensor 16 and to transform sensor signals 18 into input signals x. In an alternative embodiment, sensor signals 18 are received directly as input signals x without receiving unit 22. Each input signal x may be a portion of each sensor signal 18. Receiving unit 22 may be configured to process each sensor signal 18 to product each input signal x. Input signal x may include data corresponding to an image recorded by sensor 16.

Control system 12 includes classifier 24. Classifier 24 may be configured to classify input signals x into one or more labels using a machine learning (ML) algorithm, such as a neural network described above. Classifier 24 is configured to be parametrized by parameters, such as those described above (e.g., parameter θ). Parameters θ may be stored in and provided by non-volatile storage 26. Classifier 24 is configured to determine output signals y from input signals x. Each output signal y includes information that assigns one or more labels to each input signal x. Classifier 24 may transmit output signals y to conversion unit 28. Conversion unit 28 is configured to covert output signals y into actuator control commands 20. Control system 12 is configured to transmit actuator control commands 20 to actuator 14, which is configured to actuate computer-controlled machine 10 in response to actuator control commands 20. In some embodiments, actuator 14 is configured to actuate computer-controlled machine 10 based directly on output signals y.

Upon receipt of actuator control commands 20 by actuator 14, actuator 14 is configured to execute an action corresponding to the related actuator control command 20. Actuator 14 may include a control logic configured to transform actuator control commands 20 into a second actuator control command, which is utilized to control actuator 14. In one or more embodiments, actuator control commands 20 may be utilized to control a display instead of or in addition to an actuator.

In some embodiments, control system 12 includes sensor 16 instead of or in addition to computer-controlled machine 10 including sensor 16. Control system 12 may also include actuator 14 instead of or in addition to computer-controlled machine 10 including actuator 14.

As shown in FIG. 5, control system 12 also includes processor 30 and memory 32. Processor 30 may include one or more processors. Memory 32 may include one or more memory devices. The classifier 24 (e.g., ML algorithms) of one or more embodiments may be implemented by control system 12, which includes non-volatile storage 26, processor 30 and memory 32.

Non-volatile storage 26 may include one or more persistent data storage devices such as a hard drive, optical drive, tape drive, non-volatile solid-state device, cloud storage or any other device capable of persistently storing information. Processor 30 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 32. Memory 32 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 30 may be configured to read into memory 32 and execute computer-executable instructions residing in non-volatile storage 26 and embodying one or more ML algorithms and/or methodologies of one or more embodiments. Non-volatile storage 26 may include one or more operating systems and applications. Non-volatile storage 26 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 30, the computer-executable instructions of non-volatile storage 26 may cause control system 12 to implement one or more of the ML algorithms and/or methodologies as disclosed herein. Non-volatile storage 26 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 12 configured to control vehicle 50, which may be an at least partially autonomous vehicle or an at least partially autonomous robot. As shown in FIG. 5, vehicle 50 includes actuator 14 and sensor 16. Sensor 16 may include one or more video sensors, radar sensors, ultrasonic sensors, LiDAR sensors, and/or position sensors (e.g. GPS). One or more of the one or more specific sensors may be integrated into vehicle 50. Alternatively, or in addition to one or more specific sensors identified above, sensor 16 may include a software module configured to, upon execution, determine a state of actuator 14. One non-limiting example of a software module includes a weather information software module configured to determine a present or future state of the weather proximate vehicle 50 or other location.

Classifier 24 of control system 12 of vehicle 50 may be configured to detect objects in the vicinity of vehicle 50 dependent on input signals x. In some embodiments, output signal y may include information characterizing the vicinity of objects to vehicle 50. Actuator control command 20 may be determined in accordance with this information. The actuator control command 20 may be used to avoid collisions with the detected objects.

In embodiments where vehicle 50 is an at least partially autonomous vehicle, actuator 14 may be embodied in a brake, a propulsion system, an engine, a drivetrain, or a steering of vehicle 50. Actuator control commands 20 may be determined such that actuator 14 is controlled such that vehicle 50 avoids collisions with detected objects. Detected objects may also be classified according to what classifier 24 deems them most likely to be, such as pedestrians or trees. The actuator control commands 20 may be determined depending on the classification. The control system 12 may utilize joint adversarial training to help train the classifier and generator for adversarial conditions, such as during poor lighting conditions or poor weather conditions of the vehicle environment.

In some embodiments where vehicle 50 is an at least partially autonomous robot, vehicle 50 may be a mobile robot that is configured to carry out one or more functions, such as flying, swimming, diving, and stepping. The mobile robot may be an at least partially autonomous lawn mower or an at least partially autonomous cleaning robot. In such embodiments, the actuator control command 20 may be determined such that a propulsion unit, steering unit and/or brake unit of the mobile robot may be controlled such that the mobile robot may avoid collisions with identified objects.

In some embodiments, vehicle 50 is an at least partially autonomous robot in the form of a gardening robot. In such embodiment, vehicle 50 may use an optical sensor as sensor 16 to determine a state of plants in an environment proximate vehicle 50. Actuator 14 may be a nozzle configured to spray chemicals. Depending on an identified species and/or an identified state of the plants, actuator control command 20 may be determined to cause actuator 14 to spray the plants with a suitable quantity of suitable chemicals.

Vehicle 50 may be an at least partially autonomous robot in the form of a domestic appliance. Non-limiting examples of domestic appliances include a washing machine, a stove, an oven, a microwave, or a dishwasher. In such a vehicle 50, sensor 16 may be an optical sensor configured to detect a state of an object which is to undergo processing by the household appliance. For example, in the case of the domestic appliance being a washing machine, sensor 16 may detect a state of the laundry inside the washing machine. Actuator control command 20 may be determined based on the detected state of the laundry.

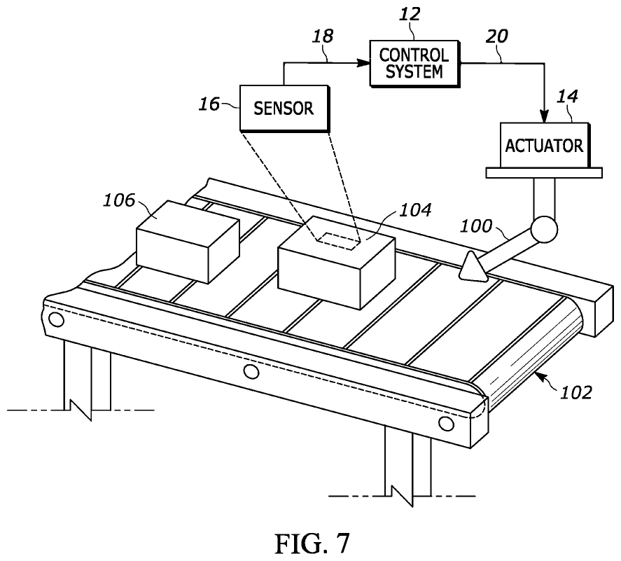

FIG. 7 depicts a schematic diagram of control system 12 configured to control system 100 (e.g., manufacturing machine), such as a punch cutter, a cutter or a gun drill, of manufacturing system 102, such as part of a production line. Control system 12 may be configured to control actuator 14, which is configured to control system 100 (e.g., manufacturing machine).

Sensor 16 of system 100 (e.g., manufacturing machine) may be an optical sensor configured to capture one or more properties of manufactured product 104. Classifier 24 may be configured to determine a state of manufactured product 104 from one or more of the captured properties. Actuator 14 may be configured to control system 100 (e.g., manufacturing machine) depending on the determined state of manufactured product 104 for a subsequent manufacturing step of manufactured product 104. The actuator 14 may be configured to control functions of system 100 (e.g., manufacturing machine) on subsequent manufactured product 106 of system 100 (e.g., manufacturing machine) depending on the determined state of manufactured product 104. The control system 12 may utilize joint adversarial training to help train the classifier and generator for adversarial conditions, such as during poor lighting conditions or working conditions difficult for the sensors to identify conditions, such as lots of dust.

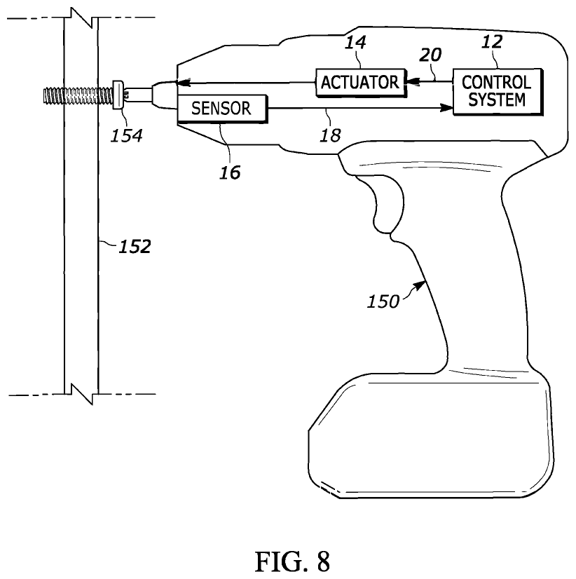

FIG. 8 depicts a schematic diagram of control system 12 configured to control power tool 150, such as a power drill or driver, that has an at least partially autonomous mode. Control system 12 may be configured to control actuator 14, which is configured to control power tool 150.

Sensor 16 of power tool 150 may be an optical sensor configured to capture one or more properties of work surface 152 and/or fastener 154 being driven into work surface 152. Classifier 24 may be configured to determine a state of work surface 152 and/or fastener 154 relative to work surface 152 from one or more of the captured properties. The state may be fastener 154 being flush with work surface 152. The state may alternatively be hardness of work surface 152. Actuator 14 may be configured to control power tool 150 such that the driving function of power tool 150 is adjusted depending on the determined state of fastener 154 relative to work surface 152 or one or more captured properties of work surface 152. For example, actuator 14 may discontinue the driving function if the state of fastener 154 is flush relative to work surface 152. As another non-limiting example, actuator 14 may apply additional or less torque depending on the hardness of work surface 152. The control system 12 may utilize joint adversarial training to help train the classifier and generator for adversarial conditions, such as during poor lighting conditions or poor weather conditions. Thus, the control system 12 may be able to identify environment conditions of the power tool 150.

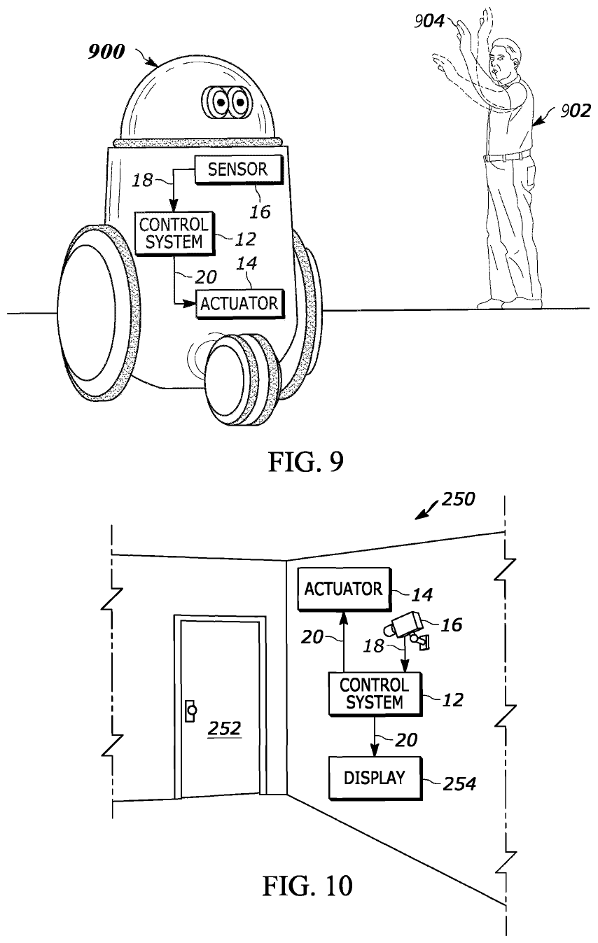

FIG. 9 depicts a schematic diagram of control system 12 configured to control automated personal assistant 900. Control system 12 may be configured to control actuator 14, which is configured to control automated personal assistant 900. Automated personal assistant 900 may be configured to control a domestic appliance, such as a washing machine, a stove, an oven, a microwave or a dishwasher.

Sensor 16 may be an optical sensor and/or an audio sensor. The optical sensor may be configured to receive video images of gestures 904 of user 902. The audio sensor may be configured to receive a voice command of user 902.

Control system 12 of automated personal assistant 900 may be configured to determine actuator control commands 20 configured to control system 12. Control system 12 may be configured to determine actuator control commands 20 in accordance with sensor signals 18 of sensor 16. Automated personal assistant 900 is configured to transmit sensor signals 18 to control system 12. Classifier 24 of control system 12 may be configured to execute a gesture recognition algorithm to identify gesture 904 made by user 902, to determine actuator control commands 20, and to transmit the actuator control commands 20 to actuator 14. Classifier 24 may be configured to retrieve information from non-volatile storage in response to gesture 904 and to output the retrieved information in a form suitable for reception by user 902. The control system 12 may utilize joint adversarial training to help train the classifier and generator for adversarial conditions, such as during poor lighting conditions or poor weather conditions. Thus, the control system 12 may be able to identify gestures during such conditions.

FIG. 10 depicts a schematic diagram of control system 12 configured to control monitoring system 250. Monitoring system 250 may be configured to physically control access through door 252. Sensor 16 may be configured to detect a scene that is relevant in deciding whether access is granted. Sensor 16 may be an optical sensor configured to generate and transmit image and/or video data. Such data may be used by control system 12 to detect a person's face. The control system 12 may utilize joint adversarial training to help train the classifier and generator for adversarial conditions during poor lighting conditions or in the case of an intruder of an environment of the control monitoring system 250.

Classifier 24 of control system 12 of monitoring system 250 may be configured to interpret the image and/or video data by matching identities of known people stored in non-volatile storage 26, thereby determining an identity of a person. Classifier 24 may be configured to generate and an actuator control command 20 in response to the interpretation of the image and/or video data. Control system 12 is configured to transmit the actuator control command 20 to actuator 14. In this embodiment, actuator 14 may be configured to lock or unlock door 252 in response to the actuator control command 20. In some embodiments, a non-physical, logical access control is also possible.

Monitoring system 250 may also be a surveillance system. In such an embodiment, sensor 16 may be an optical sensor configured to detect a scene that is under surveillance and control system 12 is configured to control display 254. Classifier 24 is configured to determine a classification of a scene, e.g. whether the scene detected by sensor 16 is suspicious. Control system 12 is configured to transmit an actuator control command 20 to display 254 in response to the classification. Display 254 may be configured to adjust the displayed content in response to the actuator control command 20. For instance, display 254 may highlight an object that is deemed suspicious by classifier 24.

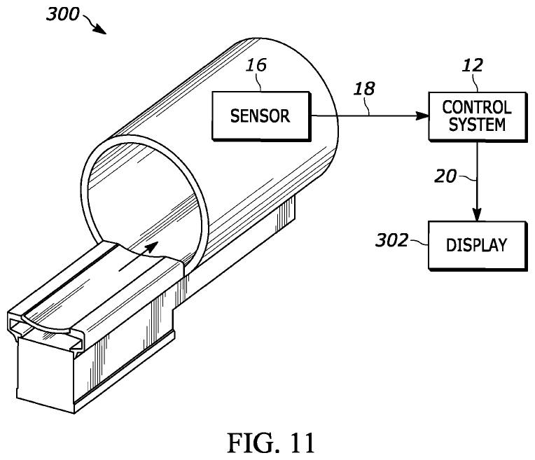

FIG. 11 depicts a schematic diagram of control system 12 configured to control imaging system 300, for example an MRI apparatus, x-ray imaging apparatus or ultrasonic apparatus. Sensor 16 may, for example, be an imaging sensor. Classifier 24 may be configured to determine a classification of all or part of the sensed image. Classifier 24 may be configured to determine or select an actuator control command 20 in response to the classification obtained by the trained neural network. For example, classifier 24 may interpret a region of a sensed image to be potentially anomalous. In this case, actuator control command 20 may be determined or selected to cause display 302 to display the imaging and highlighting the potentially anomalous region. The control system 12 may utilize joint adversarial training to help train the classifier and generator for adversarial conditions during an X-ray, such as poor lighting.

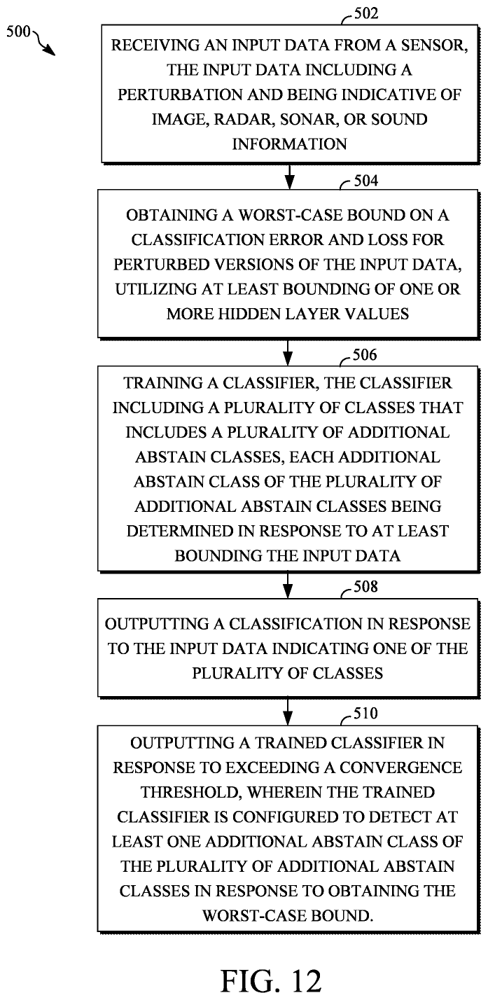

FIG. 12 is a flow diagram generally illustrating a classifier training method 500 according to the principles of the present disclosure. At 502, the method 500 receives an input data from a sensor. For example, the processor 304 may receive the input data from a sensor. The input data may include a perturbation and may be indicative of image, radar, sonar, or sound information.

At 504, the method 500 obtains a worst-case bound on a classification error and loss for perturbed versions of the input data, utilizing at least bounding of one or more hidden layer values. For example, the processor 304 may obtain the worst-case bound on the classification error and loss for perturbed versions of the input data, utilizing at least bounding of one or more hidden layer values.

At 506, the method 500 trains a classifier. For example, the processor 304 may train the classifier. The classifier may include a plurality of classes, including a plurality of additional abstain classes. Each additional abstain class of the plurality of additional abstain classes may be determined in response to at least bounding the input data.

At 508, the method 500 outputs a classification in response to the input data indicating one of the plurality of classes. For example, the processor 304 may output the classification in response to the input data indicating one of the plurality of classes.

At 510, the method 500 outputs a trained classifier in response to exceeding a convergence threshold. For example, the processor 304 may output the trained classifier in response to exceeding the convergence threshold. The trained classifier may be configured to detect at least one additional abstain class of the plurality of additional abstain classes in response to obtaining the worst-case bound.

In some embodiments, a method for training a machine-learning network includes receiving an input data from a sensor. The input data includes a perturbation and the input data is indicative of image, radar, sonar, or sound information. The method also includes obtaining a worst-case bound on a classification error and loss for perturbed versions of the input data, utilizing at least bounding of one or more hidden layer values. The method also includes training a classifier, where the classifier includes a plurality of classes, including a plurality of additional abstain classes. Each additional abstain class of the plurality of additional abstain classes is determined in response to at least bounding the input data. The method also includes outputting a classification in response to the input data indicating one of the plurality of classes and outputting a trained classifier in response to exceeding a convergence threshold. The trained classifier is configured to detect at least one additional abstain class of the plurality of additional abstain classes in response to obtaining the worst-case bound.

In some embodiments, the method also includes classifying the input data as an abstain class in response to the input data including the perturbation or adversarial information. In some embodiments, the plurality of classes includes original classes corresponding to the input data. In some embodiments, the method also includes determining a hidden value upper bound and hidden value lower bound associated with a hidden value of a network layer of the machine-learning network. In some embodiments, the one or more hidden layer values is associated with a last layer of the machine-learning network. In some embodiments, the plurality of classes includes original classes corresponding to the input data, wherein the classifier does not classify the input data as the original classes when the input data includes perturbations. In some embodiments, the method also includes bounding a training objective function by a worst-case upper bound utilizing an interval bound propagation (IBP) technique.

In some embodiments, a system, including a machine-learning network, also includes an input interface configured to receive input data from a sensor, wherein the sensor includes a video, radar, LiDAR, sound, sonar, ultrasonic, motion, or thermal imaging sensor. The system also includes a processor, in communication with the input interface, configured to: receive an input data from a sensor, the input data being indicative of image, radar, sonar, or sound information; train a classifier, the classifier including a plurality of classes, including a plurality of additional abstain classes, each additional abstain class of the plurality of additional abstain classes being determined in response to at least bounding input data including one or more perturbations; and output a trained classifier configured to detect at least one additional abstain class of the plurality of additional abstain classes in response in response to exceeding a convergence threshold.

In some embodiments, the classifier is further configured to detect the at least one additional abstain class of the plurality of additional abstain classes in response to the input data including one or more perturbations. In some embodiments, the processor is further configured to utilize interval bound propagation to compute a worst-case bound on a classification error and classification loss associated with perturbed versions of the input data. In some embodiments, the processor is further configured to compute an upper bound associated with training of the machine-learning network. In some embodiments, the processor is further configured to compute an upper bound and lower bound of the input data. In some embodiments, the processor is further configured to compute a hidden value upper bound and hidden value lower bound associated with the hidden value of a network layer.

In some embodiments, a system includes a processor and a memory. The memory includes instructions that, when executed by the processor, cause the processor to: receive input data from a sensor, wherein the sensor includes a video, radar, LiDAR, sound, sonar, ultrasonic, motion, or thermal imaging sensor, wherein the input data is indicative of an image; obtain a worst case bound on a classification error and loss associated with perturbed versions of the input data, utilizing at least bounding of one or more hidden layer values; train a classifier of a machine-learning network, wherein the classifier includes a plurality of classes, including a plurality of additional abstain classes, wherein each additional abstain class of the plurality of additional abstain classes is determined in response to at least bounding input data including one or more perturbations; and output a trained classifier configured to detect at least one additional abstain class of the plurality of additional abstain classes in response to exceeding a convergence threshold.

In some embodiments, the instructions further cause the processor to operate a physical system based on output data, wherein the physical system is a computer-controlled machine, a robot, a vehicle, a domestic appliance, a power tool, a manufacturing machine, a personal assistant, or an access control system. In some embodiments, the instructions further cause the processor to classify the input data as an abstain class in response to the input data including the one or more perturbations or adversarial information. In some embodiments, the plurality of classes includes original classes corresponding non-perturbation classification associated with the input data. In some embodiments, the instructions further cause the processor to compute an upper bound associated with training of the machine-learning network. In some embodiments, the plurality of classes except the plurality of additional abstain classes are utilized to classify a non-perturbation class. In some embodiments, the machine-learning network is a neural network.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for training a machine-learning network, the method comprising:
receiving an input data from a sensor, wherein the input data includes a perturbation, wherein the input data is indicative of image, radar, sonar, or sound information;
obtaining a worst-case bound on a classification error and loss for perturbed versions of the input data, utilizing at least bounding of one or more hidden layer values;
training a classifier, wherein the classifier includes a plurality of classes, including a plurality of additional abstain classes, wherein each additional abstain class of the plurality of additional abstain classes is determined in response to at least bounding the input data;
outputting a classification in response to the input data indicating one of the plurality of classes; and
outputting a trained classifier in response to exceeding a convergence threshold, wherein the trained classifier is configured to detect at least one additional abstain class of the plurality of additional abstain classes in response to obtaining the worst-case bound.

2. The method of claim 1, further comprising classifying the input data as an abstain class in response to the input data including the perturbation or adversarial information.

3. The method of claim 1, wherein the plurality of classes includes original classes corresponding to the input data.

4. The method of claim 1, further comprising determining a hidden value upper bound and hidden value lower bound associated with a hidden value of a network layer of the machine-learning network.

5. The method of claim 1, wherein the one or more hidden layer values is associated with a last layer of the machine-learning network.

6. The method of claim 1, wherein the plurality of classes includes original classes corresponding to the input data, wherein the classifier does not classify the input data as the original classes when the input data includes perturbations.

7. The method of claim 1, further comprising bounding a training objective function by a worst-case upper bound utilizing an interval bound propagation (IBP) technique.

8. A system including a machine-learning network, comprising:
an input interface configured to receive input data from a sensor, wherein the sensor includes a video, radar, LiDAR, sound, sonar, ultrasonic, motion, or thermal imaging sensor;
a processor, in communication with the input interface, wherein the processor is configured to:
receive an input data from a sensor, wherein the input data is indicative of image, radar, sonar, or sound information;
train a classifier, wherein the classifier includes a plurality of classes, including a plurality of additional abstain classes, wherein each additional abstain class of the plurality of additional abstain classes is determined in response to at least bounding input data including one or more perturbations; and
output a trained classifier configured to detect at least one additional abstain class of the plurality of additional abstain classes in response in response to exceeding a convergence threshold.

9. The system of claim 8, wherein the classifier is further configured to detect the at least one additional abstain class of the plurality of additional abstain classes in response to the input data including one or more perturbations.

10. The system of claim 8, wherein the processor is further configured to utilize interval bound propagation to compute a worst-case bound on a classification error and classification loss associated with perturbed versions of the input data.

11. The system of claim 10, wherein the processor is further configured to compute an upper bound associated with training of the machine-learning network.

12. The system of claim 8, wherein the processor is further configured to compute an upper bound and lower bound of the input data.

13. The system of claim 12, wherein the processor is further configured to compute a hidden value upper bound and hidden value lower bound associated with the hidden value of a network layer.

14. A system comprising:
a processor; and
a memory including instructions that, when executed by the processor, cause the processor to:
receive input data from a sensor, wherein the sensor includes a video, radar, LiDAR, sound, sonar, ultrasonic, motion, or thermal imaging sensor, wherein the input data is indicative of an image;
obtain a worst case bound on a classification error and loss associated with perturbed versions of the input data, utilizing at least bounding of one or more hidden layer values;
train a classifier of a machine-learning network, wherein the classifier includes a plurality of classes, including a plurality of additional abstain classes, wherein each additional abstain class of the plurality of additional abstain classes is determined in response to at least bounding input data including one or more perturbations; and
output a trained classifier configured to detect at least one additional abstain class of the plurality of additional abstain classes in response to exceeding a convergence threshold.

15. The system of claim 14, wherein instructions further cause the processor to operate a physical system based on output data, wherein the physical system is a computer-controlled machine, a robot, a vehicle, a domestic appliance, a power tool, a manufacturing machine, a personal assistant, or an access control system.

16. The system of claim 14, wherein the instructions further cause the processor to classify the input data as an abstain class in response to the input data including the one or more perturbations or adversarial information.

17. The system of claim 14, wherein the plurality of classes includes original classes corresponding non-perturbation classification associated with the input data.

18. The system of claim 14, wherein the instructions further cause the processor to compute an upper bound associated with training of the machine-learning network.

19. The system of claim 14, wherein the plurality of classes except the plurality of additional abstain classes are utilized to classify a non-perturbation class.

20. The system of claim 14, wherein the machine-learning network is a neural network.
